(19) United States
(12) Patent Application Publication
(10) Pub. No.: US 2025/0378398 A1
(43) Pub. Date: Dec. 11, 2025

(54) SYSTEM AND METHOD FOR SYNCHRONOUSLY CLUSTERING WORK ITEMS

(71) Applicant: DevRev, Inc., Palo Alto, CA (US)

(72) Inventors: Dominik Damjakob, Austin, TX (US); Ritesh Goru, Bangalore (IN)

(73) Assignee: DevRev, Inc., Palo Alto, CA (US)

(21) Appl. No.: 18/734,577

(22) Filed: Jun. 5, 2024

(51) Int. Cl. G06Q 10/0631

(52) U.S. Cl. CPC G06Q 10/0631

(57) ABSTRACT

A clustering system for synchronously clustering work items is provided. The clustering system comprises a user interface configured to enable a user to define one or more parameters. The clustering system further includes a clustering module communicatively coupled to the user interface and configured to retrieve a plurality of work items based on the one or more parameters, retrieve a plurality of embeddings corresponding to the plurality of work items and generate a plurality of work group by clustering embeddings with vector similarities. Each work group comprises a set of homogenous work items, in other words similar work items.

### BACKGROUND

The invention generally relates to the field of data analysis and more particularly, to a system and method for synchronously clustering work items.

Service centers, to deliver uninterrupted service towards achieving business efficiency, employ various systems to track customer feedback and/or requests. Ticketing systems is an example of one such system which is responsible for handling huge volumes of work items or tickets generated by large enterprise organizations.

When handling work items and associated conversations encapsulated in the work item, it is useful to be able to associate these tickets with specific topics. This enables a customer-support system to provide customers and product developers with comprehensive view of commonly occurring issues. This information about specific topics also facilitates improving the products and the service.

However, work items accumulated by an organization can be large in number, with counts often ranging in the tens of thousands of items. In order to view a specific set of work items, simple filtering may result in an output of hundreds or sometimes thousands of work items. It is often very challenging to review or even act on large number work items in a timely and efficient manner.

Another challenge is the difficulty for users of the ticketing system to track active work items relevant to the customers, for example, product features commonly requested, or problems reported by customers and the like. Further, users may also find it arduous to keep track of active work items that is relevant to the product developers. In addition, users may also find it time consuming to sift through the large number of work items to locate a specific problem area reported by customers.

Therefore, there is a need for a clustering system that can synchronously cluster work items based on parameters defined by the user while limiting the number of work items to a manageable level.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a clustering system for synchronously clustering work items is provided. A clustering system for synchronously clustering work items is provided. The clustering system comprises a user interface configured to enable a user to define one or more parameters. The clustering system further includes a clustering module communicatively coupled to the user interface and configured to retrieve a plurality of work items based on the one or more parameters, retrieve a plurality of embeddings corresponding to the plurality of work items and generate a plurality of work group by clustering embeddings with vector similarities. Each work group comprises a set of homogenous work items.

In another embodiment, a method for synchronously clustering a plurality of data items is provided. The method comprises defining, by a user, one or more parameters to define the plurality of work items, retrieving the plurality of work items related to the one or more parameters and retrieving a plurality of embeddings corresponding to the plurality of work items. The method further includes generating a plurality of work group by clustering embeddings with vector similarities; wherein each work group comprises a set of homogenous work items.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of an embodiment of a clustering system for clustering a plurality of work items, implemented according to aspects of the present technique;

FIG. 2 is a flow chart describing one method by work group is generated, implemented according to aspects of the present technique;

FIG. 3 and FIG. 4 are examples of a user interface implemented according to aspects of the present technique; and

FIG. 5 is a block diagram of an embodiment of a computing device in which the modules of the clustering system for clustering a plurality of work items described herein are implemented.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present invention provide systems and methods for clustering a plurality of work items. As used herein, a work item may include a ticket representing a customer request and/or problem, issues, reuse, interactions between two entities such as a customer and a customer service representative, customer accounts, opportunities, contacts, invoices, knowledge base articles, frequently asked questions and related answers (like FAQs), platform users, customer workspaces, parts and the like. The clustering system is described in further detail below.

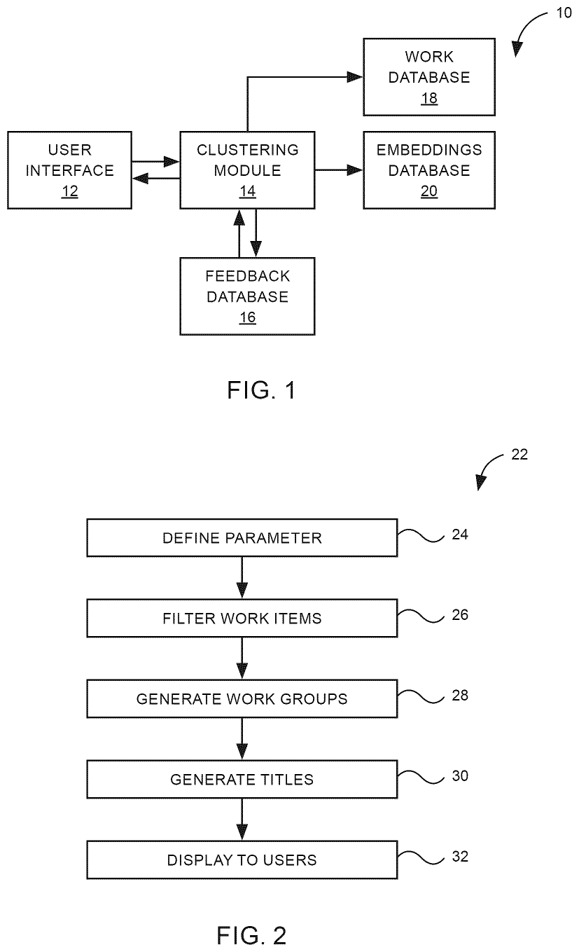

FIG. 1 is a block diagram of an embodiment of a clustering system implemented according to aspects of the present technique. The clustering system includes a user interface 12, clustering module 14, feedback module 16, work database 18 and embedding database 20. Each component is described in further detail below.

User interface 12 is configured to enable a user to define one or more parameters related to a plurality of work items. Examples of the parameters include work items assigned to a particular username, a date range, a keyword, and the like. In one embodiment, the user selects a specific parameter from a drop-down menu. The user may also enter a specific parameter in a tab on the user interface.

Clustering module 14 is communicatively coupled to user interface 12 and is configured to retrieve a plurality of work items from work database 18. Clustering module 14 is configured to apply a clustering model on embeddings of the plurality of work items to synchronously cluster and work groups comprising homogenous work items. The embeddings of the work items are retrieved from embeddings database 20. It may be noted that the homogenous work items form a subset of the plurality of work items. In one embodiment, the homogenous work items are related to a similar problem or request.

It may be noted that synchronous clustering enables users to gain faster insights into larger groups of work items. For example, users can generate synchronous clusters for new ticket work items thus enabling them to visualize current trends. Users are enabled to also generate synchronous clusters for work items created for a specific customer which allows for categorization of requests. Further, users may generate synchronous clusters for work items that are active at any given point. Also, users may generate synchronous clusters for work items assigned to specific point of contact within the organization which would allow for easy tracking.

Clustering model 14 is further configured to generate a title for each work group. In one embodiment, the work group title is based one or more recurring keywords of the identified set of homogenous work items. In another embodiment, the cluster titles instead summarize the underlying topic or direction of the work groups as indicated by their work titles.

Clustering module 14 is further configured to generate a summary for each work group. In one embodiment the summary includes a count of the number of work items, the average age of the work items, the count of work items attached to a feature part, the count of work items attached to an enhancement part and the like. The work group and the corresponding work group title, and the summary are displayed to the one or more users via the user interface.

User interface 12 is further configured to enable the one or more users to interactively provide feedback for the work group generated by the clustering module. In one embodiment, the user provides feedback in the form of a thumbs-up/thumbs-down button. The feedback is used by the clustering model 14 to evaluate an accuracy of the work group. Feedback database 16 is coupled to the clustering module and configured to receive and store the feedback provided by the one or more users.

As descried herein, the clustering system is configured to cluster a plurality of work items to generate a work group. The manner in which the work group is generated is described in further detail below.

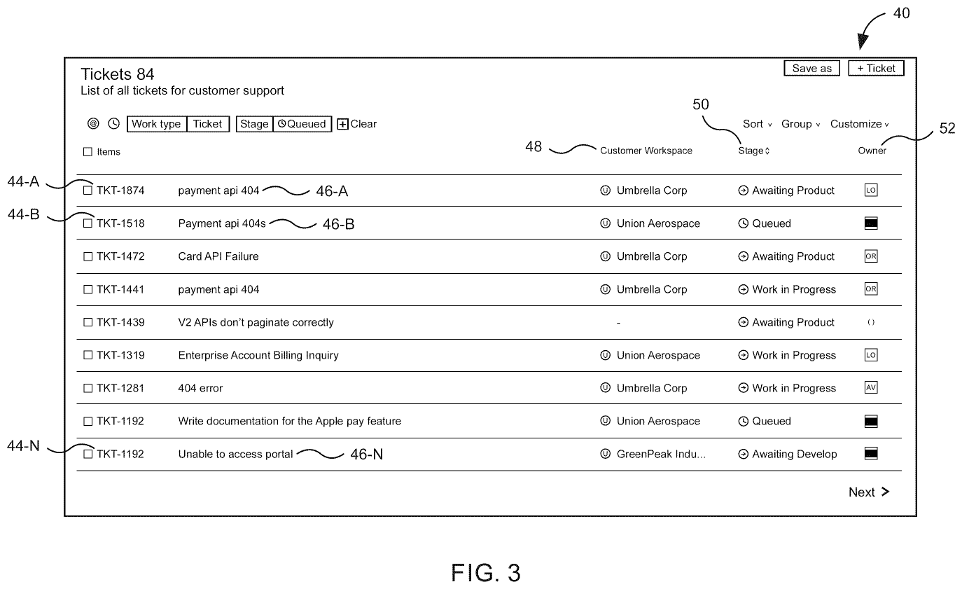

FIG. 2 is a flow chart describing one method by work group is generated, implemented according to aspects of the present technique. The work group is generated based on parameters that are defined by a user. The parameters may be defined via a user interface. Each step of the process 22 is described in further detail below.

At step 24, one or more parameters to defined by a user to filter a plurality of work items. In one embodiment, the plurality of work items are tickets raised by customer service personnel in response to queries or reports raised by customers. For example, the parameters include filters based on a time the work items were created or modified. Filters may also be based on an entity that was assigned to the work item, a status of the work item, etc.

At step 26, the plurality of work items filtered based on the one or more parameters is retrieved. In one embodiment, the number of items retrieved at this stage ranges from a lower limit of 10 to an upper limit of 9999. Further, a plurality of embeddings corresponding to the plurality of work items is also retrieved. In one embodiment, embeddings for the work items are generated using an embedding model that transforms a title and a description of a work item into a vector representation.

At step 28, a plurality of work groups is generated by clustering embeddings with vector similarities. In one embodiment, each work group comprises a set of homogenous work items. In one embodiment, a clustering model is used to generate the plurality of work groups. Examples of clustering models used include variants of DBScan models or K-Mean models. In one embodiment, the clustering model is optimized to generate work group with a maximum spread of work items across the work groups.

At step 30, a title for each work group is generated. In one embodiment, the title is generated based one or more recurring keywords in the set of homogenous work items. Further, a summary for each work group is also generated. The summary includes a snapshot of the corresponding work group and may include details such as number of work items, a date range, etc.

At step 32, each work group and the corresponding work group title and the summary is displayed to the users. In one embodiment, the users view the work groups via the user interface. The user interface is interactive and enables the user to provide feedback about the work groups. The feedback for each work group is used to evaluate accuracy of the work group. Further, the feedback may also be provided to the clustering model for implementation while generating further work groups. Example user interfaces used by the clustering system is described in detail below.

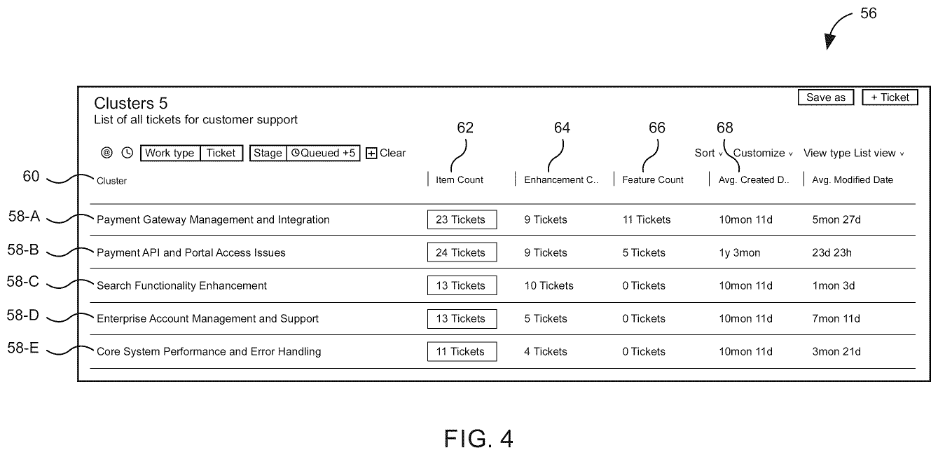

FIG. 3 is an example user interface that enables a user to view a plurality of work items at a given time. For the purpose of this example, the work items are referred to as tickets. User interface 40 comprises displays to a user a list of tickets named generally 44-A, 44-B through 44-N. Each ticket includes further data such as a description 46-A and an origin workplace indicated by column 48. Status 50 provides a status of each ticket and owner 52 provides details about a contact person for each ticket.

As can be seen, tickets 44-A through 44-N are in a random order and does not provide the user with details such as if the tickets are for a similar issue and does not show any relationship between individual tickets. However, once the clustering model is implemented the plurality of tickets are segregated into work groups as shown in FIG. 4

FIG. 4 is an example user interface that enables the user to view multiple work groups created from the tickets 44-A through 44-N from FIG. 3. As can be seen in user interface 56, five work groups have been created indicated by reference numerals 58-A, 58-B through 58-E. It may also be noted that each work group has a title and corresponding summary.

Each work group has a title field 60 with the title of the work group. Item count 62 indicates a number of tickets in each work group. Enhancement count 64 and feature count 66 indicate to the user a number of work items that have already been assigned to enhancements or features, which form a more specific part category than products or capability. In one embodiment, if the enhancement count and the feature count of a cluster is similar to the work item count of the cluster, it indicates to the user the work items in the cluster have already been resolved. Further details regarding the number of days that the ticket has stayed open and an average time taken for an action to be completed is also provided by column 68.

It may be noted from the above screenshots that the clustering system provides the user with many advantages including clustering similar tickets into a single cluster and providing related information. It is also seen that the number of tickets per group is limited to a manageable number. In one embodiment, the number of work items in each group is in the range of more than a thousand work items.

The above described invention provides several advantages including enabling users to inspect a large number of work items efficiently and to identify key areas of interest based on the work items, both in the near term and the long term. Further, by summarising the underlying topic of each work group, the user is provided with a snapshot of the work group. In addition, the synchronous clustering allows for the user to gather insights into characteristics of the work group, such as an age of a work group, etc. Moreover, the synchronous clustering technique described herein also enables users to take actions on work groups and update the work group accordingly.

The various actions, acts, blocks, steps, or the like as described above may be performed in the order presented, in a different order or simultaneously. Further, in some embodiments, some of the actions, acts, blocks, steps, or the like may be omitted, added, modified, skipped, or the like without departing from the scope of the invention.

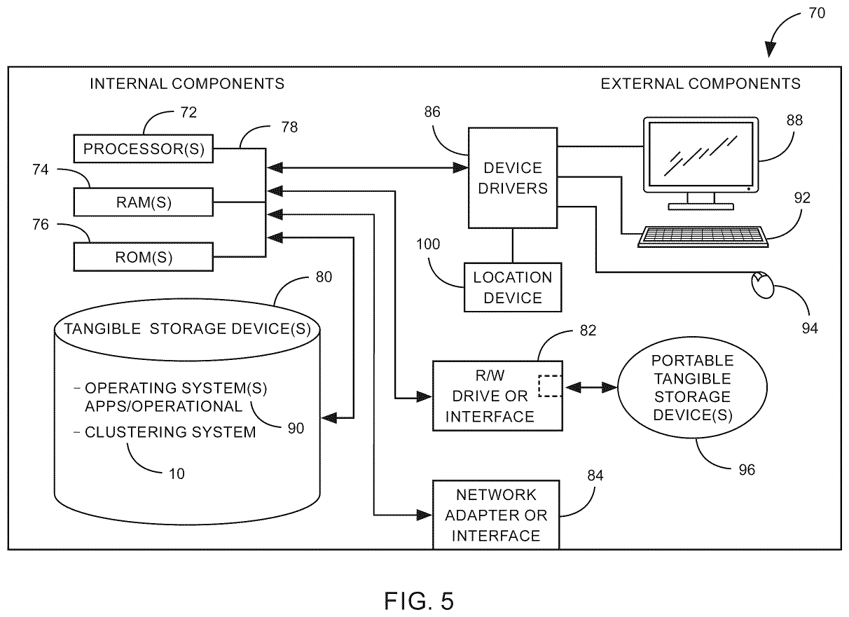

The clustering system described herein is implemented using a computing device such as computing device 70 is described below in FIG. 5. The computing device 70 includes one or more processor(s) 72, one or more computer-readable RAMs 74 and one or more computer-readable ROMs 76 on one or more buses 78. Further, computing device 70 includes a tangible storage device 80 that may include clustering system 10 for clustering a plurality of work items. The various modules of the system 10 may be stored in the tangible storage device 80. Both, the operating systems 90 and the system 10 are executed by the one or more processor(s) 72 via one or more respective RAMs 74 (which typically include cache memory). The execution of the operating systems 90 and/or the system 10 by the one or more processor(s) configures the one or more processor(s) as a special purpose processor configured to carry out the functionalities of the operation systems) and/or the system 10 as described above.

Examples of the tangible storage device include semiconductor storage devices such as ROM, EPROM, flash memory or any other computer-readable tangible storage device that may store a computer program and digital information.

Computing device 70 also includes a R/W drive or interface 82 to read from and write to one or more portable computer-readable tangible storage devices 96 such as a CD-ROM, DVD, memory stick or semiconductor storage device. Further, network adapters or interfaces 84 such as a TCP/IP adapter cards, wireless Wi-Fi interface cards, or 3G or 4G wireless interface cards or other wired or wireless communication links are also included in computing device.

In one example embodiment, the system clustering 10 may be stored in the tangible storage device and may be downloaded from an external computer via a network (for example, the Internet, a local area network or other, wide area network) and network adapter or interface.

Computing device 70 further includes device drivers 86 to interface with input and output devices. The input and output devices may include a computer display monitor 88, a keyboard 92, a keypad, a touch screen, a computer mouse 94, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

1. A clustering system for synchronously clustering work items; the clustering system comprising:
a user interface configured to enable a user to define one or more parameters;
a clustering module communicatively coupled to the user interface and configured to:
retrieve a plurality of work items based on the one or more parameters;
retrieve a plurality of embeddings corresponding to the plurality of work items;
generate a plurality of work groups by clustering embeddings with vector similarities;
wherein each work group comprises a set of homogenous work items.

2. The system of claim 1, wherein the clustering module is further configured to generate a title for each work group based on a topic present in the identified set of homogenous work items.

3. The system of claim 2, wherein the clustering module is further configured to generate a summary for each work group.

4. The system of claim 2; wherein each work group and the corresponding work group title and the summary are displayed to the one or more users via the user interface.

5. The system of claim 2, wherein the clustering module is further configured to enable the one or more users to interactively provide feedback to evaluate an accuracy of the work groups.

6. The system of claim 5, further comprising a feedback module coupled to the clustering module and configured to receive and store the feedback provided by the one or more users.

7. The system of claim 1, further comprising a work database coupled to the clustering module and configured to store a plurality of work items received from a plurality of sources.

8. The system of claim 1, further comprising an embedding database configured to stores the plurality of embeddings.

9. The system of claim 1, wherein a size of the work group is based on the clustering model.

10. A method for synchronously clustering a plurality of data items; the method comprising:
defining one or more parameters to define the plurality of work items; wherein the one or more parameters are defined by a user;
retrieving the plurality of work items related to the one or more parameters;
retrieving a plurality of embeddings corresponding to the plurality of work items;
generating a plurality of work group by clustering embeddings with vector similarities;
wherein each work group comprises a set of homogenous work items.

11. The method of claim 10; wherein the plurality of work groups is generated by implementing a clustering model.

12. The method of claim 10, further comprising generating a title for each work group based on a topic present in the identified set of homogenous work items.

13. The method of claim 12, further comprising generating a summary for each work group.

14. The system of claim 13; further comprising displaying the plurality of work groups and the corresponding work group titles and summaries to the one or more users.

15. The method of claim 14, further comprising dynamically receiving feedback about the work group and evaluating an accuracy of the work group.

16. The method of claim 15; further comprising providing the received feedback to the clustering model to improve the accuracy of the generated work groups.

17. The method of claim of 10; further comprising storing the plurality of work items and corresponding embeddings in a database.

18. A computer program product embodied on a computer readable medium, the computer readable medium having stored thereon a sequence of instructions which, when executed by a processor, executes at least:
defining one or more parameters to define the plurality of work items; wherein the one or more parameters are defined by a user;
retrieving the plurality of work items related to the one or more parameters;
retrieving a plurality of embeddings corresponding to the plurality of work items;
generating a plurality of work group by clustering embeddings with vector similarities;
wherein each work group comprises a set of homogenous work items.
